(19) United States
(12) Patent Application Publication
(10) Pub. No.: US 2021/0374814 A1
(43) Pub. Date: Dec. 2, 2021

(54) A RECONCILIATION SYSTEM BASED ON HYBRID CLOUD COMPUTING PLATFORM AND ITS RECONCILIATION METHOD

(71) Applicant: SHENZHEN JINGTAI TECHNOLOGY CO., LTD., Guangdong (CN)

(72) Inventors: Yanpeng MA, Guangdong (CN); Shuaikang LIN, Guangdong (CN); Yang LIU, Guangdong (CN); Jian MA, Guangdong (CN); Shuhao WEN, Guangdong (CN)

(73) Assignee: SHENZHEN JINGTAI TECHNOLOGY CO., LTD., Guangdong (CN)

(21) Appl. No.: 16/973,775

(22) PCT Filed: Dec. 25, 2019
(86) PCT No.: PCT/CN2019/128190

§ 371 Date: Dec. 10, 2020

(51) Int. Cl. G06Q 30/04; G06Q 30/02; G06F 9/48; G06F 9/50; G06F 9/54

(52) U.S. Cl. CPC G06Q 30/04; G06Q 30/0206; G06F 9/541; G06F 9/5072; G06F 9/4881

(57) ABSTRACT

The invention provides a reconciliation system and method based on a hybrid cloud computing platform. The reconciliation system includes: a bill data processing module, processing data from a public cloud billing API or downloaded bill detailed files; a data monitoring processing module, processing the data collected from the resource pool of the computing management system resource pool and task resource requested; a task data processing module obtaining and processing task data from the task database of the computing scheduling system, and calculating the core hours that the tasks consumed; a statistical alarm module combining the resource data table obtained by the above three modules to obtain the utilization ratio and difference range of the computing task packing can realize the reconciliation alarm and prediction for task core hours. The computing power demand for a large number of existing tasks can be used to guide the purchase of computing power in the future.

### FIELD OF THE INVENTION

The invention pertains to the technical field of data processing, and specifically relates to a reconciliation system based on a hybrid cloud computing platform and its reconciliation method.

### BACKGROUND OF THE INVENTION

Nowadays, enterprise services are hosted on the public cloud, and it is more and more common to purchase a large amount of computing resources through cloud service providers instead of self-built local computing servers. When directly connecting to a single cloud service provider, you can directly obtain the monthly usage cost through the corresponding cloud service provider billing system, and manually download the billing details file to calculate the usage and cost of each service, as well as the computing pool usage and cost. But the technology has the following problems.

(1) This kind of reconciliation is strongly bound to the architecture of a single cloud service provider, and cross-cloud and local computing need to be separately and manually calculated which increases the difficulty of cost evaluation of different cloud service providers.

(2) There is no unified standard for the data structure and service name of different cloud service providers' billing products, which makes it difficult for users to aggregate computing results in unified accounting and cannot analyze and process historical data of multi-cloud services.

(3) Due to the empty running problem caused by resource packing and elastic scaling of the computing task scheduling system, there is a certain loss in actual computing resource usage, thus it is impossible to know the computing resources that need to be applied for the actual computing task operation, and the corresponding cost control for the actual task is lacking.

### SUMMARY OF THE INVENTION

In order to solve the above technical problems, this invention provides a reconciliation system based on a hybrid cloud computing platform and a reconciliation method, which is suitable for the field of high-performance computing, combined with monitoring and alarm systems, to achieve computing resource cost accounting and statistics of actual utilization ratio of multi-cloud service providers.

The technical solution adopted is a reconciliation system based on hybrid cloud computing platform, comprising:

Based on the differences of cloud service providers and the support of the statement interface, the bill data processing module can directly obtain the detailed bill file through the API interface, or manually download the file, or get detailed data through the object storage of the bill file storage. Due to the different types of computing instances of each cloud provider, the number of virtual cores is diverse, and the billing time zone is also inconsistent. It is necessary to calculate the unified data information such as the total cost, the cost per instance, the cost per core hour and the total core hours based on the billing cycle of each cloud service provider.

By task data processing module, the scheduling system of the computing platform will recording task life cycle, CPU consumption, memory consumption and other parameter data in the database according to start, run and complete status of the actual task. Through analysis and processing of the task database, the core hours consumed by each computing task and the time occupied by the scheduled computing instance can be calculated.

By the data monitoring processing module, the monitoring system of the computing platform will collect the CPU information of each computing cluster, including the total number of CPUs, the number of CPUs used by the task request, the number of CPUs actually used by the task, and the number of CPUs that form a time series in the database. Through the analysis and processing of this time series database, the core hours consumed by computing cluster and actually used by the tasks can be obtained. It can be used to compare the billing data and the task data.

The statistical alarm module. Through the analysis and integration of the processing data of the above three modules, the statistical alarm module can obtain the three-party periodic core hour table, and also can obtain the correspondence between the bill data computing instance and the task data Computing instance based on the computing instance id. When the utilization ratio meets the benchmark and is consistent with the data monitoring error, the reconciliation is correct, otherwise, the abnormal place of the reconciliation will be alerted. And based on historical reconciliation data, it can predict the core hour consumption of the next reconciliation cycle, and the unit time cost, etc.

The reconciliation method of the reconciliation system based on the hybrid cloud computing platform is specifically coordinated by four modules. The steps for each module are described below:

(1) The billing data processing module. First, the statistical interface layer of this module completes the access to the cloud provider. Generally, in order to maintain uniformity, it will wait for all the cloud vendors' monthly detailed bills to be generated before triggering the reconciliation system, then checks whether the detailed bills of all supported cloud vendors are complete, and uses a unified interface layer to obtain cloud computing total cost, instance cost, total consumed core hours and other data information and save the information in the database permanently.

(2) The task data processing module can be run in real time or can be synchronized by triggering the reconciliation system. First, it checks whether the database has entered the current cycle data. If not, it will obtain the start and end time of task operation, the number of cores, and the running computing instance data from the life cycle data of the computing task of the scheduling system to obtain the core hours of each computing task as cost information, and obtain the time-consuming period of the computing instance where the computing task is located, and compare it with the bill processing data.

(3) The data monitoring processing module can run in real time, or can be synchronized by triggering the reconciliation system. First, it checks whether the data in the current cycle has been processed. If not, it will obtain the number of CPU cores in the public cloud resource pool at the sequential time point and the number of CPU cores actually applied for by the computing tasks from the collection timing database of the alarm system to obtain the core hour consumption of the cycle time, as the comparison data between the billing cycle and the task cycle.

(4) Statistical alarm module: when the above steps (1), (2) and (3) completed, this module can obtain the tripartite comparison table of core hour data between the current cycle bill and monitoring computing pool, comparison table of task core hour data with monitoring task core hour data, and comparison table of the bill core hour data with task core hour data. Based on the computing instance ID, the matched computing instance ID data table can be obtained from the bill processing database and the task processing database, thereby efficiently and accurately obtaining the utilization ratio of computing task packing and the difference range, to determine whether there is problem or not of some vender's data. Based on aggregated reconciliation views of these data tables, you can see the cloud provider-level core hour consumption, unit cost, and core time utilization ratio, to estimate the next cycle core hour consumption and budget.

The reconciliation method of a reconciliation system based on a hybrid cloud computing platform provided by this invention has the following technical effects:

(1) By integrating the billing API and billing detail data of major public cloud vendors, the differences between public clouds are further eliminated, and billing data in a standard format can be provided, and data views can be output, which is a resource for users to better understand the resource usage of the computing tasks.

(2) Through a series of data processing modules, the data can be analyzed and processed to understand the computing power cost and computing power utilization ratio of the actual computing task, and guide the cost management of future computing tasks.

(3) Through the introduction of data monitoring, it is ensured that any data problem of any party in the tripartite reconciliation can be discovered in time.

### BRIEF DESCRIPTION OF THE DRAWINGS

FIG. 1 is a schematic diagram of the principle of the reconciliation method of this invention.

FIG. 2 is a schematic diagram of the structure of the reconciliation system of this invention.

FIG. 3 is a flowchart of the reconciliation system of this invention.

FIG. 4 is a schematic diagram of the structure of this invention for docking with the outside when in use.

### DESCRIPTION OF THE PREFERRED EMBODIMENT

The technical solutions of the present invention will be further described in detail below with the drawings and embodiments.

The reconciliation of computing resources needs to be accurate and efficient. The reconciliation method is flexible with easy and automatic operation. The reconciliation cycle can be set flexibly and supports different time zones, and can be set monthly, quarterly, or daily according to the support of cloud vendors. It also can be done according to different resource types. The result of the reconciliation can guide the application of computing resources in the next cycle, alarm for abnormal accounting, and the abnormal data records can be viewed.

### Embodiment1

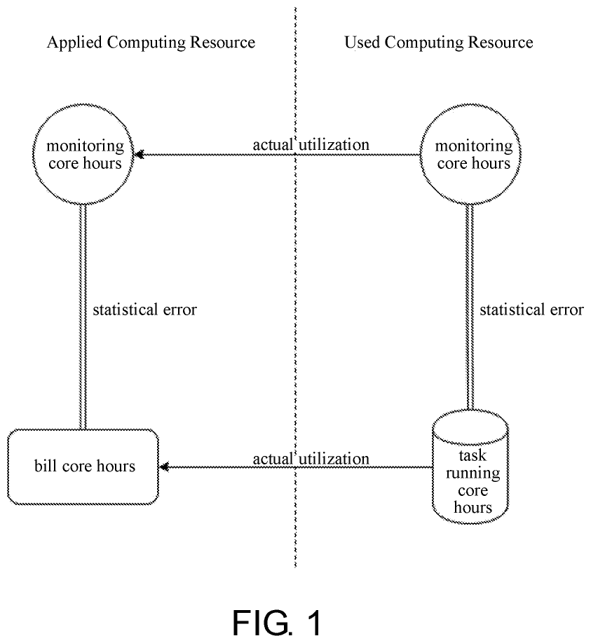

This invention provides an account reconciliation method. FIG. 1 shows a schematic diagram of the principle of the reconciliation method of this invention.

After the detailed bill of reconciliation cycle coming out, the computation core hours can be calculated according to the number of cores of the computing instance and running time interval of each public cloud platform, and the applied computing core hours of the current cycle can be calculated according to the time series computing pool cores of the data monitoring. By monitoring the reconciliation between the applied core hours and the bill core hours, it is determined whether the error range exceeds the threshold. According to the cores that the tasks requested and operating life cycle of the task data, the actual computing core hours of this cycle can be calculated, and the actual computing amount of core hours used in this cycle can be calculated according to the time series task cores of data monitoring. Monitoring the reconciliation between the actual usage of the core hours and the task core hours to determine whether the error range exceeds the threshold.

However, the data monitoring has a certain bias relative to the real data. The utilization ratio calculated according the monitoring task core hours and the monitoring applied core hours is roughly equal to the utilization ratio calculated by the task operation core hours and the billing core hours. Through the difference between the two utilization ratios, determine whether the difference range exceeds the threshold.

Through this three-party reconciliation, the reconciliation of computing resources can be obtained relatively quickly.

### Embodiment2

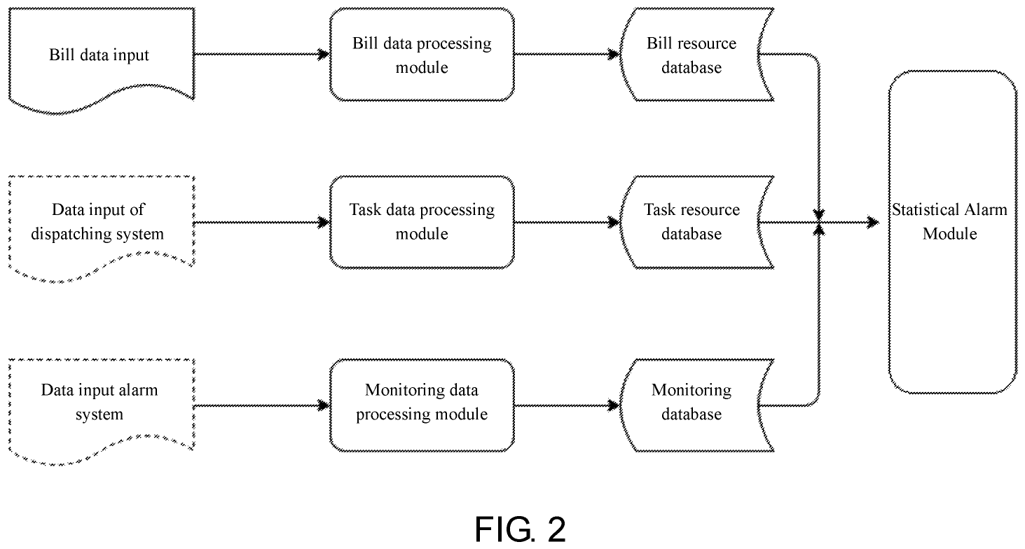

This invention also provides a reconciliation system. FIG. 2 shows a schematic structural diagram of the second embodiment of the reconciliation system of this invention. It includes four modules: a bill data processing module, a task data processing module, a data monitoring processing module, and a statistical alarm module. In high-performance hybrid cloud computing, the billing data processing module has the following attributes after billing data processed:

| | | | | | |
|---|---|---|---|---|---|
| Public | Computing | Computing | CPU/GPU | Unit Price of | Running Time Interval |
| Cloud | Instance | Instance ID | Cores of | Computing | of Computing Instance |
| Vender | Type | | Computing | Instance | |
| | | | Instance | | |

According to the computing instance running interval and unit price, the computing instance cost can be calculated. According to the computing instance running time interval and the number of cores of the computing instance, the computation core hours=the number of cores×time (hours). That is, the cost and the computation core hours of the computing resources from the start to the end can be calculated. The computing instance ID is used as the reconciliation identification code of the usage flow of computation.

There are various computing instances including bidding instances, on-demand instances, annual fee instances, etc. The corresponding physical cores of different models are also different. Here, the 1 u of each public cloud is used as a core, and one core hour is a standard measurement unit of computation amount, the unit price for core hour is the cost of one core hour. According to the different forms of billing data input, the billing processing module can either periodically call the billing API of the public cloud service provider for billing data processing, or periodically process the detailed billing file stored in the object storage such as s3, or download the corresponding monthly billing details file and manually trigger the bill processing, then dump the processed data in the database.

| | | | CPU/GPU | Unit Price of | |
|---|---|---|---|---|---|
| Public | Computing | | Cores of | Computing | |
| Cloud | Instance | Computing | Computing | Instance | Running Time Interval |
| Vender | Type | Instance ID | Instance | (RMB) | of Computing Instance |
| Cloud A | A1 | X | 36 | 3.8 | 2019-10-02T19:00:00Z/ |
| | | | | | 2019-10-02T21:00:00Z |
| Cloud B | B2 | Y | 16 | 1 | 2019-10-05T10:00:00Z/ |
| | | | | | 2019-10-05Tll:30:20Z |
| Cloud C | C3 | Z | 32 | 3.5 | 2019-10-06T10:00:00Z/ |
| | | | | | 2019-10-06T10:20:35Z |

The task data processing module is to obtain the relevant data of the task operation from the time point of the status feedback from the task start to the end. The records processed have the following attributes:

| | | | | |
|---|---|---|---|---|
| Public Cloud | Task ID | Computing | CPU/GPU Cores | Running Time |
| Vender | | Instance ID | applied by | Interval of |
| | | | the task | the task |

According to number of cores that the task applied and the total running time, the computation amount of the core hours can be calculated. In addition, the cost range of the computing task is estimated by the unit price of the core hour, which corresponds to the user who submits the task. The computing instance ID is used as the reconciliation identification code of the computation amount.

| | | | CPU/GPU Cores | Running Time |
|---|---|---|---|---|
| Public Cloud | | Computing | applied by | Interval of |
| Vender | Task ID | Instance ID | the task | the task |
| Cloud A | X | A1 | 8 | 1571378400, |
| | | | | 1571392800 |
| Cloud B | X | B2 | 8 | 1571392800, |
| | | | | 1571450400 |
| Cloud C | Y | C3 | 16 | 1572248262, |
| | | | | 1572314400 |

The data monitoring processing module periodically obtains the real-time time series number of cores of computing resource pool as well as real-time time series number of cores of running container from the monitoring collection database, and calculates the number of cores of the actual packed tasks.

| | | | |
|---|---|---|---|
| Public Cloud | The number of | The number of | Time point |
| Vender | cores of the | cores of the task | |
| | resource pool | | |

According to the data at different time points of the number of cores of the resource pool and the number of cores of the task, the computation amount of the resource pool core hours and task core hours can be estimated. According to the historical fluctuation data of the resource pool, the total number of cores of the computation required in a short period of time can also be estimated to facilitate the estimation of the purchase limit for the public cloud computing instance in the next cycle.

| | The number of | | |
|---|---|---|---|
| Public Cloud | cores of the | The number of | |
| Vender | resource pool | cores of the task | Time point |
| Cloud A | 50000 | 49000 | 1572248260 |
| Cloud B | 10000 | 9200 | 1572248250 |
| Cloud C | 3000 | 2800 | 1572248240 |

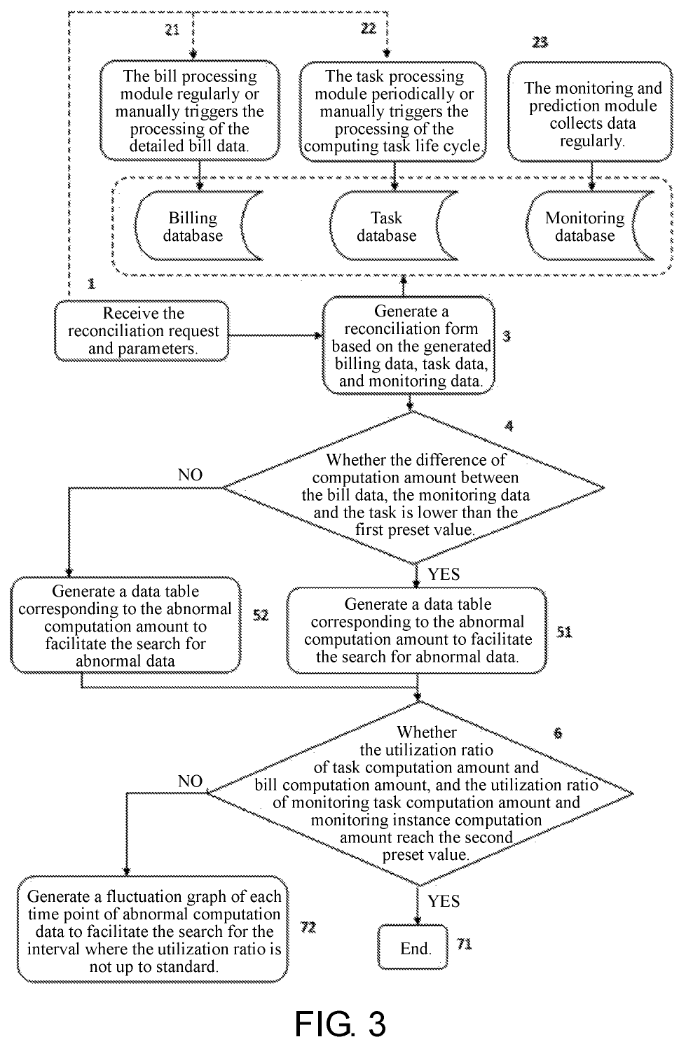

Finally, as shown in FIG. 3, a detailed reconciliation table and a tripartite reconciliation form with the computing instance ID as the reconciliation identifier are generated through the statistical alarm module. Due to the scheduling delay of the computing task and the matching problem of packing, the actual computation amount of the computing task and the computation amount of the applied computing instance are different to a certain extent. The core hour utilization ratio of the computing instance is taken as the computation flow data.

By checking whether the difference between the bill core hours and the monitoring resource pool core hours the task core-hour and the monitoring task container core hour exceeds the threshold of 2%, it is judged whether one of the party's core hour data is incorrect. If the difference is too large, you need to generate a detailed data comparison table to compare the abnormal time point data. If it is within the normal range, the computation amount forecast table for the computing instance purchase in the next cycle is generated. Then, the utilization ratio of the task packing is obtained according to the ratio of the task core hours to the bill core hours, to see if it is consistent with the core-hour utilization ratio of the data monitoring, and the core-hour utilization ratio of the computing instance is used as a review and reconciliation. Through the reconciliation system, the actual use cost and actual use efficiency of the computation task finally reach the present value and be known well.

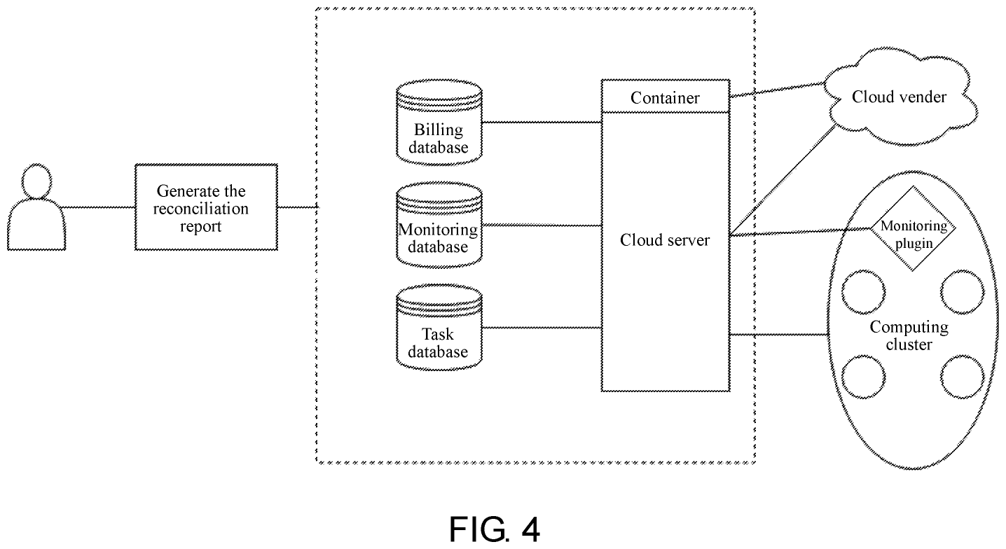

After a host and database applied on the cloud and related operation permissions attached, this invention can be run then, as shown in FIG. 4. When a user submits a reconciliation application, a reconciliation report can be formed through the database generated by the reconciliation system.

1. A reconciliation system, comprising:
a billing data processing module, processing data from a public cloud billing API or downloaded billing detailed files;
a data monitoring processing module, obtaining task, requesting resources from a monitoring system of a computing platform, and processing the data;
a task data processing module, obtaining and processing task data from a task database of a scheduling system of the computing platform; and
a statistical alarm module, obtaining a data comparison table from bill monitoring data and the task data, alerting users according to a reconciliation difference threshold, and using historical reconciliation data to guide future cost management.

2. A method for reconciliation of the reconciliation system according to claim 1, comprising:
1) processing, by the bill data processing module, the data, according to a detailed bill of a public cloud service provider to generate the bill, calculating a cost of a computing power data of an instance to be processed by subsequent processes of the reconciliation system;
2) obtaining, by the task data processing module, start and end time of task operation and applying core hour data from a lifecycle database of computing tasks stored in a computing platform scheduling system, thereby obtaining an amount of core hour consumed by each computing task as cost information
3) obtaining, by the data monitoring processing module, data from the database collected by the monitoring system of the computing platform, wherein the collected data includes a number of CPU cores at each time point in each public cloud resource pool and a number of CPU cores actually applied for by the computing task at each time point; through task data monitoring, obtain public cloud computing cluster monitoring core hours and task requested monitoring core hours as a control group data;
4) obtaining, by the statistical alarm module, an utilization ratio and difference range of a computing task packing according to a resource data table obtained in steps (1) to (3), and realizing a tripartite reconciliation of task core hours, and alerting on abnormal reconciliation data and accumulating historical reconciliation data to forecast and guide a management of computing cost.
